(19) United States
(12) Patent Application Publication
(10) Pub. No.: US 2024/0316769 A1
(43) Pub. Date: Sep. 26, 2024

(54) ROBOT CONTROL SYSTEM

(71) Applicant: HONDA MOTOR CO., LTD., Tokyo (JP)

(72) Inventors: Tomohiro Kawakami, Wako-shi (JP); Kenichiro Sugiyama, Wako-shi (JP); Mitsuhide Kuroda, Wako-shi (JP); Akira Mizutani, Wako-shi (JP); Tomohiro Chaki, Wako-shi (JP); Takeshi Chiku, Wako-shi (JP); Tomomi Fukui, Wako-shi (JP)

(21) Appl. No.: 18/600,959

(22) Filed: Mar. 11, 2024

(30) Foreign Application Priority Data
Mar. 22, 2023 (JP) 2023-045618

(51) Int. Cl. B25J 9/16; B25J 9/00; B25J 13/00

(52) U.S. Cl. CPC B25J 9/1664; B25J 9/0084; B25J 9/1653; B25J 13/006

(57) ABSTRACT

A robot control system includes: a communication unit configured to input and output information from and to one or more operation terminals remotely operating at least one of one or more robots; an acquisition unit configured to acquire operation input information which is input by the operation terminal; a task determining unit configured to set a task of the robot on the basis of operation details acquired by the acquisition unit and to determine which of an automatic control process and an input-requiring process requiring an input from an operator the task is; and a motion control unit configured to control a motion of the robot on the basis of automatic control data of the automatic control process and the operation input information input for the input-requiring process determined by the task determining unit.

### CROSS-REFERENCE TO RELATED APPLICATION

Priority is claimed on Japanese Patent Application No. 2023-045618, filed Mar. 22, 2023, the content of which is incorporated herein by reference.

### BACKGROUND OF THE INVENTION

### Field of the Invention

The present invention relates to a robot control system.

### Description of Related Art

Recently, anticipation of teleoperated robots has increased due to the influence of labor shortage and the like. Accordingly, systems for causing a robot to work by teleoperation have been developed. Techniques for supporting such teleoperation have been developed (for example, see Non-Patent Document 1).

In disasters, pandemics, or the like, there is demand for telework of factory workers by performing tasks to be carried out in a manufacturing line using teleoperated robots as illustrated in FIG. 11. Since a general manufacturing line requires a plurality of workers as illustrated in FIG. 11, a plurality of robots are needed for replacement of the workers with robots. FIG. 11 is a diagram illustrating scenes of a task by persons and a task by robots in a factory.

[Non Patent Document 1] Kazunori Ono, Naoshi Shiroma, “Remote Control Support Technology of Rescue Robot,” Journal of the Robot Society of Japan, Vol. 28, No. 2, pp 160-163, 2010

### SUMMARY OF THE INVENTION

However, regarding operations of robots introduced into a factory in the related art, one operator controls one robot. When one operator is intended to simultaneously handle a plurality of robots, there is a problem in that the operator does not know which robot is operated or efficient control is not possible.

An aspect of the present invention was made in consideration of the aforementioned problem, and an objective thereof is to provide a robot control system that can enable one operator to easily operate a plurality of end effectors.

In order to solve the aforementioned problem and to achieve the aforementioned objective, the present invention employs the following aspects.

(1) A robot control system according to an aspect of the present invention includes: a communication unit configured to input and output information from and to one or more operation terminals remotely operating at least one of one or more robots; an acquisition unit configured to acquire operation input information which is input by the operation terminal; a task determining unit configured to set a task of the robot on the basis of operation details acquired by the acquisition unit and to determine which of an automatic control process and an input-requiring process requiring an input from an operator the task is; and a motion control unit configured to control a motion of the robot on the basis of automatic control data of the automatic control process and the operation input information input for the input-requiring process determined by the task determining unit.

(2) In the aspect of (1), the number of robots may be two or more, and the robot control system may further include a proposal unit configured to propose an efficient arrangement of the input-requiring processes for the two or more robots.

(3) In the aspect of (1) or (2), the robot control system may further include a presentation unit configured to present position information of the robot which is operated by the operator for the input-requiring process.

(4) In the aspect of (1), the number of robots may be two or more, and the motion control unit may cause a second robot on a receiver side to predict a next motion from a motion of a first robot on a sender side and to perform a motion and may be configured to perform control such that the first robot on the sender side moves to a receiving position on the basis of the automatic control data and to perform control such that the second robot on the receiver side performs a task after waiting for the operator's operation.

(5) In the aspect of (1), the number of robots may be two or more, and the motion control unit may control a first robot on the basis of the automatic control data such that the first robot holds an operation target object and control a second robot on the basis of the operation input information such that the second robot performs a predetermined task on the operation target object.

(6) In the aspect of (1), the number of robots may be two or more, the task determining unit may select a task requiring the operator's instruction out of motions patterned in a series of tasks, and the motion control unit may allocate the task selected by the task determining unit to the input-required process, wait for an instruction from the operator, and allocate another task to the automatic control process.

(7) In the aspect of (1), the presentation unit may add information indicating that a robot is a target of the automatic control process or information indicating that a robot is a target of the input-required process to each robot and present the position information when the number of robots is two or more.

(8) In the aspect of (1), the presentation unit may add information indicating an arrangement of the two or more robots which are operated by the operator to a partial area of an image of the robots presented to the operator and present the position information.

According to the aspects of (1) to (8), it is possible to enable one operator to easily operate a plurality of end effectors.

### BRIEF DESCRIPTION OF THE DRAWINGS

FIG. 1 is a diagram schematically illustrating a robot control system according to an embodiment.

FIG. 2 is a diagram illustrating an example in which a plurality of robots perform one task.

FIG. 3 is a diagram illustrating an example of a configuration of the robot control system according to the embodiment.

FIG. 4 is a diagram illustrating an example of data which is stored in a DB.

FIG. 5 is a diagram illustrating another example of data which is stored in the DB.

FIG. 6 is a diagram illustrating a first example of a total image which is provided to an operator according to the embodiment.

FIG. 7 is a diagram illustrating a timing at which a total image which is provided to an operator according to the embodiment is displayed.

FIG. 8 is a diagram illustrating a second example of a total image which is provided to an operator according to the embodiment.

FIG. 9 is a diagram illustrating a third example of a total image which is provided to an operator according to the embodiment.

FIG. 10 is a flowchart illustrating a process flow which is performed by the robot control system according to the embodiment.

FIG. 11 is a diagram illustrating scenes of a task by persons and a task by robots in a factory.

### DETAILED DESCRIPTION OF THE INVENTION

Hereinafter, an embodiment of the present invention will be described with reference to the accompanying drawings. In the drawings used for the following description, scales of elements are appropriately changed so that the elements can be easily recognized.

In the drawings used for the following description of an embodiment, elements having the same or similar functions will be referred to by the same reference signs and repeated description thereof will be omitted.

“On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

### Example of Environment of Remote Operation Control System

An outline of a remote operation control system will be described below.

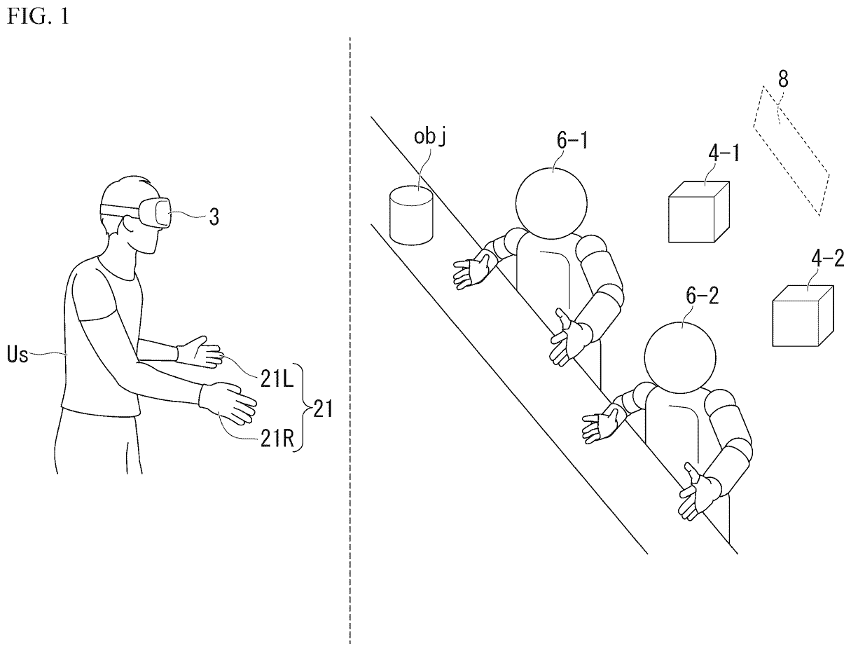

FIG. 1 is a diagram schematically illustrating a robot control system according to an embodiment.

In this embodiment, one operator Us remotely operates a plurality of robots 6 (6-1, 6-2, . . . ). The robots 6 do not perform all operations thereof in response to remote operations, but automatically perform the operations on the basis of work details, timings, or the like, and operate in response to remote operation instructions from the operator Us on the basis of the work details, the timings, or the like. In the following description, a “remote-operation process” is also referred to as an “input-required process” requiring an operation input. A “process automatically controlled by a remote control device 5” is also referred to as an “automatic-control process.”

The operator Us wears, for example, a head-mounted display (HMD) as an image display unit 3 and also wears an operation detecting unit 21 (21L, 21R) or the like.

In a work space, environment sensors 4 (4-1, 4-2, . . . ) are installed. The environment sensors 4 may be attached to the robots 6 (6-1, 6-2, . . . ). Each environment sensor 4 is, for example, an RBG (red, blue, and green) D camera also acquiring depth information D.

Each of the robots 6 (6-1, 6-2, . . . ) includes at least an arm and an end effector. Each robot 6 may include a head.

A presentation unit 8 configured to present position information of a robot operated by an operator or the like may be provided, for example, in the vicinity of the ceiling of the work space.

In the following description, it is assumed that the number of robots 6 operated by the operator Us is two, but the number of robots 6 is one or more and may be three or more. For example, one robot 6 may include two arms, and the arms may be remotely operated by one operator. With this configuration, each arm is referred to as a robot in this embodiment. That is, a first arm is a first robot, and a second arm is a second robot.

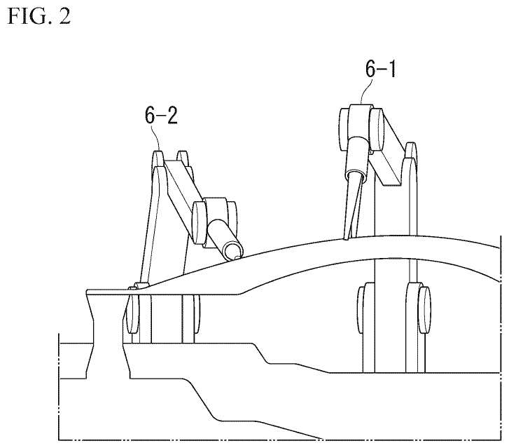

A plurality of robots 6, for example, two robots 6 as illustrated in FIG. 2, may perform one task. Specifically, a first robot 6-1 may support an object and a second robot 6-2 may perform a task on the object. FIG. 2 is a diagram illustrating an example in which a plurality of robots perform one task.

### Example of Configuration of Robot Control System

An example of a configuration of the robot control system will be described below.

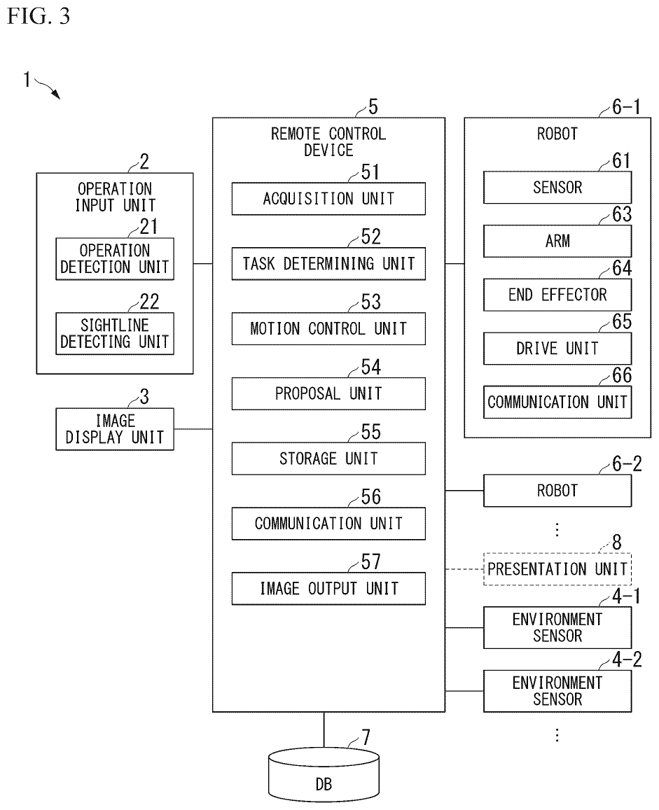

FIG. 3 is a diagram illustrating an example of a configuration of the robot control system according to the embodiment. The robot control system 1 includes, for example, an operation input unit 2 (an operation terminal), an image display unit 3 (a presentation unit), environment sensors 4 (4-1, 4-2, . . . ), a remote control device 5, robots 6 (6-1, 6-2, . . . ), a DB 7, and a presentation unit 8.

The robot control system 2 includes, for example, an operation detecting unit 21 and a sightline detecting unit 22.

The remote control device 5 includes, for example, an acquisition unit 51, a task determining unit 52, a motion control unit 53, a proposal unit 54, a storage unit 55, a communication unit 56, and an image output unit 57.

Each robot 6 includes, for example, a sensor 61, an arm 63, an end effector 64, a drive unit 65, and a communication unit 66.

The operation input unit 2 includes a communication unit which is not illustrated and performs transmission and reception of information to and from the remote control device 5 in a wired or wireless manner. The operation input unit 2 is used by an operator who remotely operates the robot 6. The number of operation input units 2 may be two or more or may correspond to the number of robots 6. When the number of operation input units 2 is one, the operation input unit 2 may sequentially correspond to one of a plurality of robots 6.

The operation detecting unit 21 detects an operation input which is input by the operator. The operation detecting unit 21 is, for example, a data glove or a switch. The operation detecting unit 21 outputs the detected operation input information to the remote control device 5.

The sightline detecting unit 22 detects a sightline of the operator. The sightline detecting unit 22 outputs the detected sightline information to the remote control device 5. The sightline detecting unit 22 may be provided in the image display unit 3. The image display unit 3 is, for example, an image display device such as an HMD, a liquid crystal image display device, an organic electroluminescence (EL) image display device, a smartphone, or a tablet terminal. The image display unit 3 displays an image which is supplied from the remote control device 5. The image display unit 3 includes a communication unit which is not illustrated and performs transmission and reception of information to and from the remote control device 5 in a wired or wireless manner. The image display unit 3 may include a touch sensor, a vibration sensor, or the like which is not illustrated. The image display unit 3 may detect an operation of the operator using such a sensor and transmit a request for switching an image to be supplied as will be described later.

Each environment sensor 4 is, for example, an RGBD camera that can acquire depth information D. Each environment sensor 4 may include a distance sensor using a laser or the like and an RGB camera. The number of environment sensors 4 may be two or more. Each environment sensor 4 includes a communication unit which is not illustrated and is connected to the remote control device 5 in a wired or wireless manner.

The remote control device 5 controls the robots 6-1, 6-2, . . . on the basis of operation input information from an operator. For example, the remote control device 5 may estimate the operator's operation intention and assist with work.

The acquisition unit 51 acquires operation input information and sightline information from the operation input unit 2. The acquisition unit 51 acquires image information from the environment sensor 4. The acquisition unit 51 acquires sensor detection values or the like from the robots 6.

The task determining unit 52 sets a task of a robot 6 on the basis of operation details acquired by the acquisition unit 51. The task determining unit 52 determines which of an automatic-control process of a task and an input-required process requiring an operator's input is to be performed.

The automatic-control process of a task is a job which can be performed without an operation instruction from an operator and is, for example, a job of pressing an object during work or a job of grasping an object and moving in the grasped state according to an operation instruction from an operator. Automatic control data of the automatic-control process of a task is generated by the task determining unit 52.

The input-required process requiring an input from an operator is a job which it is difficult to automatically process and is, for example, a job of grasping a component, a job of fastening a screw, or a job requiring a fine operation instruction from a person. Data which is input in the input-required process requiring an input from an operator is operation input information which is input from the operation input unit 2.

The motion control unit 53 controls motions of the robots 6 on the basis of automatic control data in the automatic-control process determined by the task determining unit 52 and operation input information input for the input-required process.

The proposal unit 54 calculates a timing at which a task is switched between the automatic-control process and the input-required process. The proposal unit 54 links tasks which are performed by a plurality of robots. The proposal unit 54 proposes an operator to which process a remote operation process is applied on the basis of the calculation result. For example, when one operator takes charge of three tasks (a first task, a second task, and a third task), the proposal unit 54 performs the proposal in consideration of at what timing a job requiring an input from an operator is to be efficiently performed. The proposal unit 54 may perform the proposal by displaying an image on the image display unit 3 or may perform the proposal using text or speech. The proposal unit 54 may perform the proposal along with standard work information.

The storage unit 55 stores a program, a threshold value, and the like used by the remote control device 5. The storage unit 55 may store three-dimensional model data (for example, CAD data) for each of the robots 6. The storage unit 55 stores positions at which the environment sensors 4 are installed.

The communication unit 56 communicates with one or more operation input units 2 (operation terminals) for remotely operating at least one of the robots 6 via a network.

The image output unit 57 generates an image to be presented to an operator and outputs the generated image to the image display unit 3.

The sensor 61 includes, for example, an encoder attached to a joint and a 6-axis sensor and a force sensor attached to a fingertip of an end effector 64.

The end effector 64 is attached to a tip of the arm 63.

The end effector 64 includes two or more fingers. The end effector 64 may be a gripper or include a plurality of fingers. The end effectors 64 provided in the robots 6 may differ, for example, depending on work details.

The drive unit 65 includes, for example, a drive circuit and an actuator. The drive unit 65 drives the arm 63 and the end effector 64 in accordance with a control instruction (such as a joint angle instruction) output from the remote control device 5.

The communication unit 66 outputs detection values detected by the sensors 61 to the remote control device 5. The communication unit 66 acquires control information output from the remote control device 5.

The DB 7 is a database and stores, for example, identification information for identifying a robot 6 taken charge of by an operator, work details which are performed by the robots 6, work times of the robots 6, and the like in correlation. When the number of operators is two or more, the DB 7 stores the information for each operator.

The presentation unit 8 provides an overhead view image of each of a plurality of robots 6, a total image of a plurality of robots 6, and the like. The presentation unit 8 may be installed on the ceiling of a work space in which the robots 6 work or may be virtually presented on the image display unit 3.

### Data Stored in DB

An example of data stored in the DB 7 will be described below.

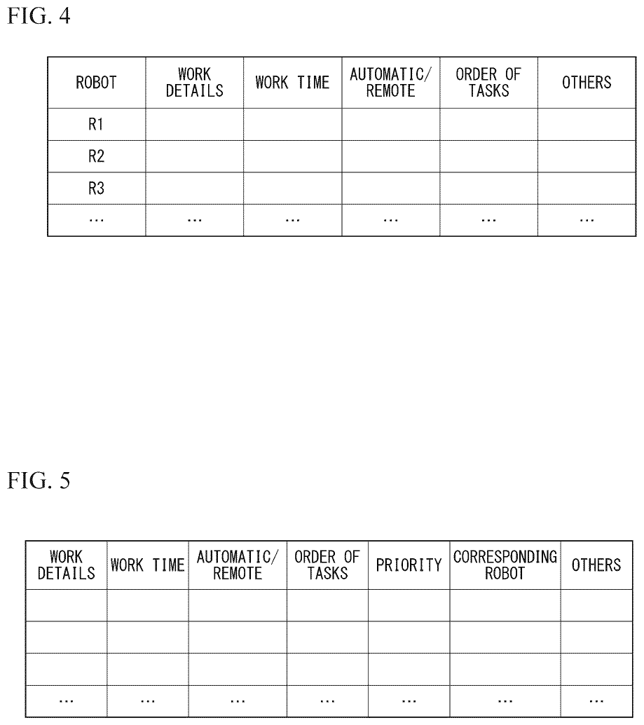

FIG. 4 is a diagram illustrating an example of data stored in the DB. In the DB 7, work details of a robot 6, a work time of the robot 6, information indicating whether to perform a task automatically or in response to a remote operation, the order of tasks, and other information are stored in correlation with identification information of each robot 6. The DB 7 may store three-dimensional model data for each of the robots 6.

The data stored in the DB 7 may be stored in advance or may be generated or changed by the remote control device 5. FIG. 5 is a diagram illustrating another example of data stored in the DB. In the DB 7, for example, a work time, information indicating whether to perform a task automatically or in response to a remote operation, the order of tasks, priority, identification information indicating a corresponding robot, and other information are stored in correlation with work details. The priority is a priority level or the priority order in a series of tasks. The priority may include information indicating tasks which are to be simultaneously performed.

### Example of Cooperation of Plurality of Robots

An example of tasks which are performed by a plurality of robots 6 will be described below.

### I. First Example

In a task according to a first example, a second robot 6-2 on a receiver side predicts a next motion from a motion of a first robot 6-1 on a sender side and performs a motion. In this case, the task determining unit 52 performs setting and control such that the first robot 6-1 on the sender side moves automatically to a receiving position, and the second robot 6-2 on the receiver side waits for an operation input from an operator and performs a remaining task.

### II. Second Example

In a second example, for example, a first robot 6-1 presses a bag and a second robot 6-2 ties a string on the bag. In this case, the task determining unit 52 automatically controls the first robot 6-1 on the pressing side and controls the second robot 6-2 on the string-tying side on the basis of a remote operation. In this task, the robots cooperatively perform the task to tie a string while pressing a bag. Another example of this task pattern is, for example, a task of causing the second robot 6-2 to perform screw coupling or attachment of a component on the basis of a remote operation while causing the first robot 6-1 to press an object.

### III. Third Example

The task determining unit 52 selects a task requiring a human instruction out of motions patterned in a series of tasks. Then, the task determining unit 52 allocates the selected task to a remote operation, waits for an instruction from an operator, and allocates another task to an automatic task.

The proposal unit 54 may propose the task allocation details to, for example, the operator.

For example, when one task is performed by three robots 6-1, 6-2, and 6-3, the task determining unit 52 may determine details or a timing of a task to be performed by an operator's remote operation, for example, on the basis of the priority or the work time and allocate the remaining task to other robots 6. Alternatively, the task determining unit 52 may determine tasks to be performed by the robots 6 and then allocate the tasks as a task to be performed by an operator's remote operation. Then, the proposal unit 54 may propose the allocation results to the operator, for example, displaying the allocation results on the image display unit 3.

For example, the task determining unit 52 may calculate efficiency on the basis of a total time required for a task and allocate and arrange a task to be automatically performed and a task to be performed on the basis of a remote operation such that the efficient is maximized. The arrangement is the order of tasks of a task to be automatically performed and a task to be performed on the basis of a remote operation and includes, for example, remote operation as a first procedure, automatic control as a second procedure, and automatic control as a third procedure. The proposal unit 54 may propose the arrangement results to the operator, for example, by displaying the arrangement results on the image display unit 3.

### Estimation of Operation Intention and Support of Operation

The remote control device 5 may estimate an operator's operation intention on the basis of operation input information or sightline information and assist with the motions of the robots 6 in remote operation (for example, see Japanese Patent Application No. 2022-006498).

For example, when a task includes grasping, the remote control device 5 estimates an operator's operation intention using GRASP Taxonomy (for example, see Reference Document 1).

The remote control device 5 classifies an operator status, for example, by classifying a posture of an operator or a robot 6, that is, a grasp posture, using GRASP Taxonomy and estimates an operator's operation intention. The remote control device 5 estimates an operator's operation intention, for example, by inputting operation information to a trained model stored in the storage unit 55. Another method may be used for classification of a grasp posture. The remote control device 5 may comprehensively estimate the operation intention using a sightline and a motion of an arm. In this case, the remote control device 5 may estimate an operator's operation intention by inputting sightline information, motion information of an arm, position information of an object on a table to a trained model.

Reference Document 1: Thomas Feix, Javier Romero and others, “The GRASP Taxonomy of Human Grasp Types” IEEE Transactions on Human-Machine Systems (Volume: 46, Issue: 1, February 2016), IEEE, p 66-77

The remote control device 5 realizes smooth grasp, for example, by supporting an operation on the basis of the operator's operation intention in addition to performing control based on the operator's instruction in remote operation.

The remote control device 5 may calculate, for example, a contact point of a finger of a robot 6 with an object at which the robot can stably grasp the object without dropping the object from a classification of a selected motion, an object shape, physical parameters such as a friction or a weight of an object to be estimated, and constraint conditions such as a torque output from the robot 6. The remote control device 5 may assist the robot with a correcting motion using a joint angle calculated therefrom as a target value (for example, see Japanese Unexamined Patent Application, First Publication No. 2022-155623).

### Example of Provision Image

An example of an image to be provided to an operator will be described below.

Since one operator takes charge of a plurality of robots 6, the operator may know an arrangement of the robots 6 or the like. Accordingly, in this embodiment, an image of a work environment in which the robots 6 perform tasks is provided, for example, in response to the operator's request.

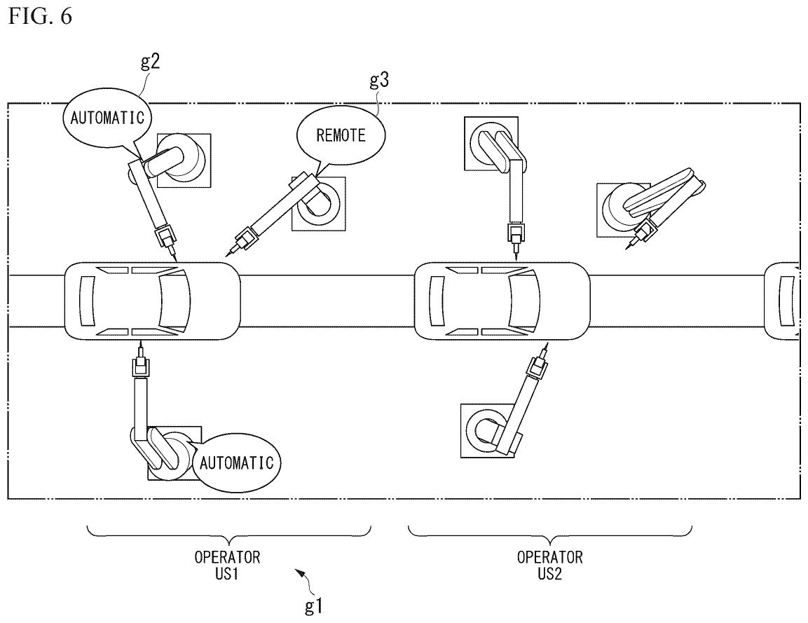

FIG. 6 is a diagram illustrating a first example of a total image which is provided to an operator according to this embodiment. As illustrated in FIG. 6, an image of a predetermined area of a work environment is provided. The image to be provided is, for example, an overhead view or a bird's-eye view. As illustrated in FIG. 6, information g1 indicating robots 6 taken charge of by operators, information g2 indicating what robot automatically works, information g3 indicating that a task is performed by remote operation on the basis of input operation information, and the like may be added to the provision image and then the provision image may be presented. As illustrated in FIG. 6, the remote control device 5 may present the provision image along with position information (arrangement information) of a robot 6 which is a remote operation target.

By additionally providing this information, an operator can easily understand where a robot 6 which is remotely operated is located. By providing an overhead view or a bird's eye view in this way, it is possible to see a work space or a work viewpoint from the overhead view or the like.

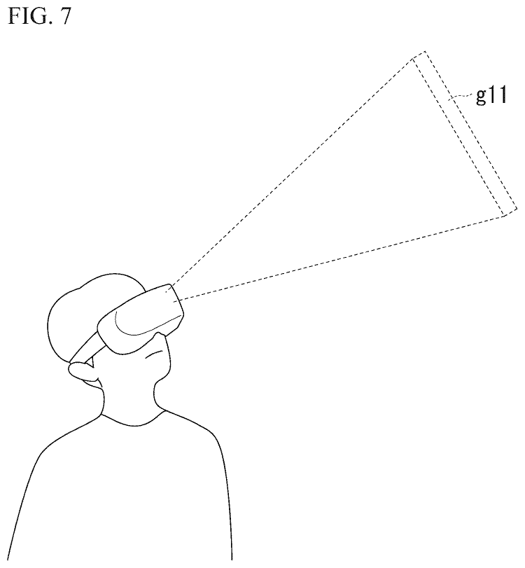

A total image g11 may be switched to be displayed on the image display unit 3, for example, when an operator sees upward (for example, the ceiling) or downward (for example, the floor) as illustrated in FIG. 7. FIG. 7 is a diagram illustrating a timing at which the total image to be provided to an operator is displayed according to this embodiment.

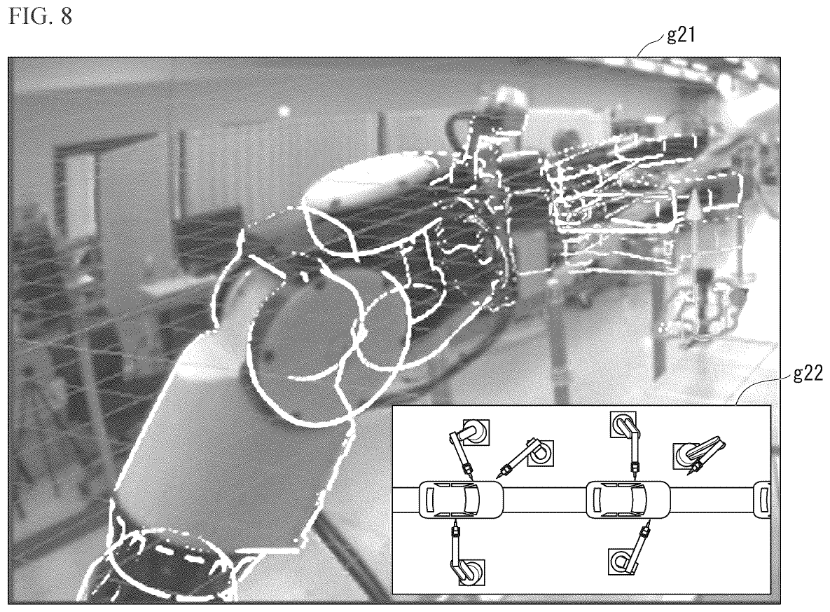

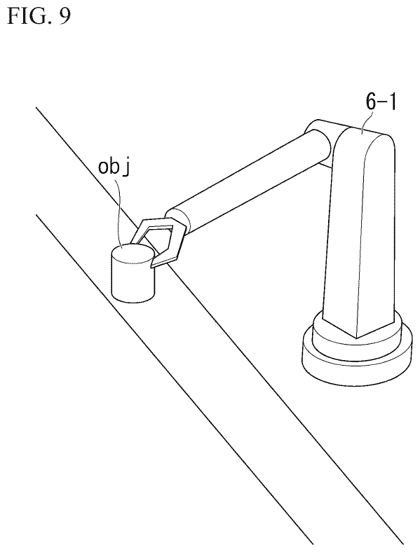

Alternatively, as illustrated in FIG. 8, a total image g22 may be presented to overlap a position which does not interfering with remote operation in an image g21 provided on the image display unit 3. This switching of display is performed, for example, on the basis of a result of an operation which has been performed on the operation input unit 2 or the image display unit 3 by an operator. FIG. 8 is a diagram illustrating a second example of a total image which is provided to an operator according to this embodiment.

The total image may be normally presented through the presentation unit 8 which is installed in a work space as illustrated in FIG. 1. The remote control device 5 may provide the image presented through the presentation unit 8 to the image display unit 3 as illustrated in FIG. 6 or 8.

The presentation image, the presentation timing, the switching method, and the like described above with reference to FIGS. 6 to 8 are only an example and the present invention is not limited thereto.

For example, an image of a robot 6 which is remotely operated in the total image illustrated in FIG. 6 may be provided in an overhead view or a bird's-eye view. In this case, when an operator operates the operation input unit 2 or the image display unit 3 in the state illustrated in FIG. 6, an overhead view image or a bird's-eye view image of the robot 6 which is remotely operated may be provided as illustrated in FIG. 9. FIG. 9 is a diagram illustrating a third example of a total image which is provided to an operator according to this embodiment. The environment sensor 4 may be installed at a position at which such an overhead view image or a bird's-eye view image can be captured. The remote control device 5 may cut out and use a part of the image captured by the environment sensor 4.

### Process Flow

An example of a process flow which is performed by the robot control system will be described below.

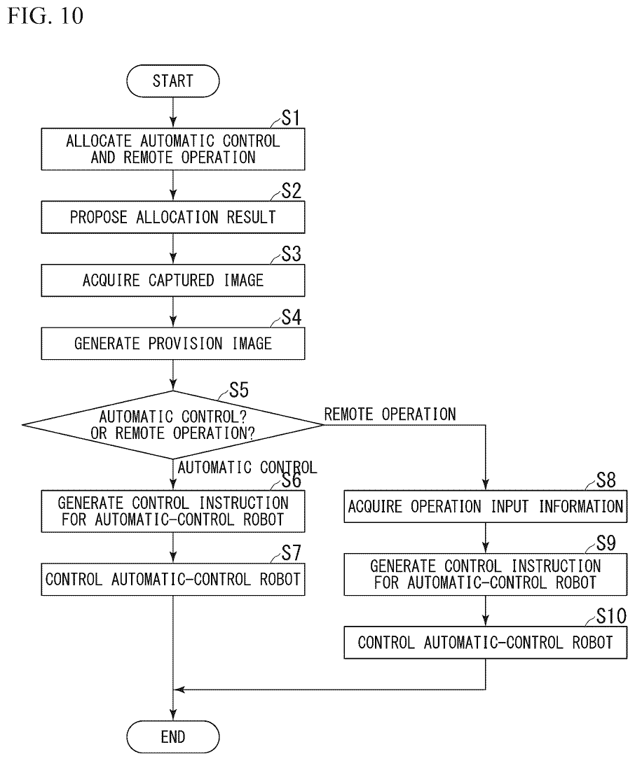

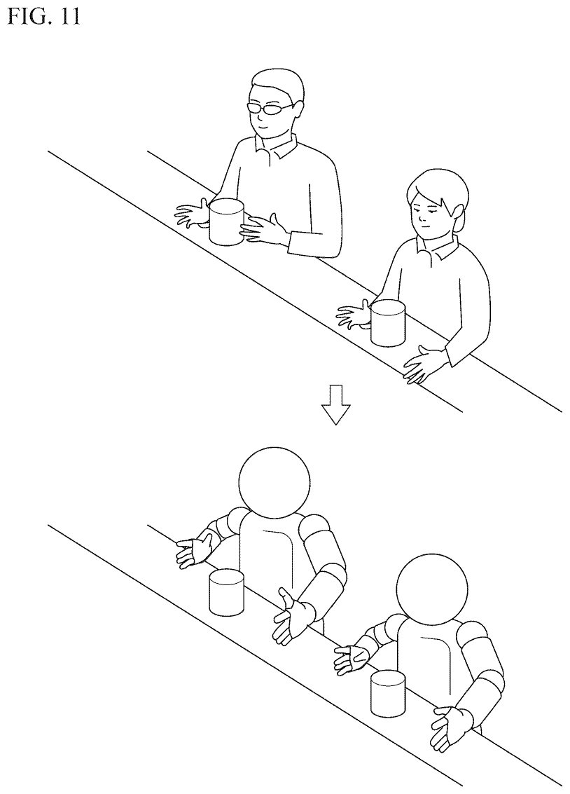

FIG. 10 is a flowchart illustrating a process flow which is performed by the robot control system according to the embodiment.

(Step S1) The task determining unit 52 allocates tasks to an automatic-control process and an input-required process requiring an input from an operator using information stored in the storage unit 55 and data stored in the DB 7. The task determining unit 52 allocates tasks to a plurality of robots 6 on the basis of the allocation result using information stored in the storage unit 55 and data stored in the DB 7.

(Step S2) The proposal unit 54 proposes the allocation result of a plurality of robots 6 to an operator, for example, by displaying the allocation result on the image display unit 3.

(Step S3) The acquisition unit 51 acquires an image captured by the environment sensor 4.

(Step S4) The image output unit 57 generates a provision image using the acquired image.

(Step S5) The task determining unit 52 determines whether a task is control for an automatic-control robot 6 (an automatic-control process) or control for a robot 6 based on a remote operation (an input-required process). When the task is the control for an automatic-control robot 6 (Step S5: automatic control), the task determining unit 52 causes the process flow to proceed to Step S6. When the task is the control for a robot 6 based on a remote operation (Step S5: remote operation), the task determining unit 52 causes the process flow to proceed to Step S8.

(Step S6) The motion control unit 53 generates automatic control data (a control instruction) for a robot 6 of the automatic-control process.

(Step S7) The motion control unit 53 controls the motion of the robot 6 of the automatic-control process using the generated control information.

(Step S8) The acquisition unit 51 acquires operation input information from the operation input unit 2.

(Step S9) The motion control unit 53 generates control data (a control instruction) for a robot 6 of the remote operation process (the input-required process).

(Step S10) The motion control unit 53 controls the motion of the robot 6 of the remote operation process using the generated control information.

The remote control device 5 sequentially or parallel performs the processes of Steps S6 to S7 and the processes of Steps S8 to S10 on the basis of work details. The remote control device 5 ends the process flow when a series of tasks end.

The process details and the process flow described above are only an example, and the present invention is not limited thereto. For example, when proposal to an operator is not necessary, the process of Step S2 may not be performed.

### Modified Examples

In the aforementioned example, one operator handles a plurality of robots 6, but the present invention is not limited thereto. The aforementioned technique can be applied to a case in which a plurality of operators handle a plurality of robots 6.

In this case, the task determining unit 52 sets the robots 6 corresponding to the operators such that corresponding times do not overlap. The proposal unit 54 may propose information on the set robots 6 corresponding to the operators (work details, the order of tasks, work timings, and the like including the information) to the plurality of operators.

As described above, in this embodiment, tasks of a plurality of robots 6 are automatically linked. In this embodiment, two or more robots 6 are simultaneously supported. In this embodiment, an operator can perform an operation in an overhead view. In this embodiment, a plurality of tasks can be simultaneously performed. In this embodiment, a total image of an operation system of the plurality of robots 6 is provided.

Accordingly, according to this embodiment, since tasks requiring cooperation of the robots 6 or the end effectors 64 are patterned in advance and control is performed such that the robots wait at positions at which a human instruction is required, it is possible to easily perform remote control.

According to this embodiment, since the order of tasks is proposed such that tasks requiring a remote instruction are efficiently arranged, it is possible to increase the number of robots 6 which can be handled by one operator.

According to this embodiment, even when the number of robots 6 to be handled increases, an operator can know a positional relationship with an environment and thus can easily understand robots which are operated by the operator.

Some or all of the processes which are performed by the robot control system 1 may be performed by recording a program for realizing all or some of the functions of the robot control system 1 according to the present invention on a computer-readable recording medium and causing a computer system to read and execute the program recorded on the recording medium. The “computer system” mentioned herein includes an operating system (OS) or hardware such as peripherals. The “computer system” may include a WWW system including a homepage provision environment (or display environment). The “computer-readable recording medium” is a portable medium such as a flexible disk, a magneto-optical disc, a ROM, or a CD-ROM and a storage device such as a hard disk incorporated into a computer system. The “computer-readable recording medium” may include a medium that holds a program for a predetermined time such as a volatile memory (RAM) in a computer system serving as a server or a client when a program is transmitted via a network such as the Internet or a communication line such as a telephone line.

The program may be transmitted from a computer system in which the program is stored in a storage device or the like to another computer system via a transmission medium or carrier waves in the transmission medium. Here, the “transmission medium” for transmitting a program is a medium having a function of transmitting information such as a network (a communication network) such as the Internet or a communication circuit line (a communication line) such as a telephone line. The program may be a program for realizing some of the aforementioned functions. The program may be a so-called differential file (a differential program) that can realize the aforementioned functions in combination with another program stored in advance in the computer system.

While a mode for realizing the present invention has been described above with reference to an embodiment, the present invention is not limited to the embodiment and can be subjected to various modifications and replacements without departing from the gist of the present invention.

What is claimed is:

1. A robot control system comprising:
a communication unit configured to input and output information from and to one or more operation terminals remotely operating at least one of one or more robots;
an acquisition unit configured to acquire operation input information which is input by the operation terminal;
a task determining unit configured to set a task of the robot on the basis of operation details acquired by the acquisition unit and to determine which of an automatic control process and an input-requiring process requiring an input from an operator the task is; and
a motion control unit configured to control a motion of the robot on the basis of automatic control data of the automatic control process and the operation input information input for the input-requiring process determined by the task determining unit.

2. The robot control system according to claim 1, wherein the number of robots is two or more, and
wherein the robot control system further comprises a proposal unit configured to propose an efficient arrangement of the input-requiring processes for the two or more robots.

3. The robot control system according to claim 1, further comprising a presentation unit configured to present position information of the robot which is operated by the operator for the input-requiring process.

4. The robot control system according to claim 1, wherein the number of robots is two or more,
wherein the motion control unit causes a second robot on a receiver side to predict a next motion from a motion of a first robot on a sender side and to perform a motion, and
wherein the motion control unit performs control such that the first robot on the sender side moves to a receiving position on the basis of the automatic control data and performs control such that the second robot on the receiver side performs a task after waiting for the operator's operation.

5. The robot control system according to claim 1, wherein the number of robots is two or more,
wherein the motion control unit controls a first robot on the basis of the automatic control data such that the first robot holds an operation target object, and
wherein the motion control unit controls a second robot on the basis of the operation input information such that the second robot performs a predetermined task on the operation target object.

6. The robot control system according to claim 1, wherein the number of robots is two or more,
wherein the task determining unit selects a task requiring the operator's instruction out of motions patterned in a series of tasks, and
wherein the motion control unit allocates the task selected by the task determining unit to the input-required process, waits for an instruction from the operator, and allocates another task to the automatic control process.

7. The robot control system according to claim 3, wherein the presentation unit adds information indicating that a robot is a target of the automatic control process or information indicating that a robot is a target of the input-required process to each robot and presents the position information when the number of robots is two or more.

8. The robot control system according to claim 3, wherein the presentation unit adds information indicating an arrangement of the two or more robots which are operated by the operator to a partial area of an image of the robots presented to the operator and presents the position information.
